(19) United States
(12) Patent Application Publication
(10) Pub. No.: US 2019/0194980 A1
(43) Pub. Date: Jun. 27, 2019

(54) ELECTRONIC ANTI-THEFT DEVICE WITH A CLAMPING FUNCTION

(71) Applicant: THOONSEN TRADING, Chateauroux (FR)

(72) Inventor: Jacky THOONSEN, CHATEAUROUX (FR)

(21) Appl. No.: 16/229,829

(22) Filed: Dec. 21, 2018

(30) Foreign Application Priority Data
Dec. 22, 2017 (FR) 1771422

(51) Int. Cl. E05B 73/00

(52) U.S. Cl. CPC E05B 73/0017; E05B 73/0052

(57) ABSTRACT

An electronic antitheft device comprising an electronic detection device, a first part and a second part, each part provided with an inner contact surface, and the first part being movable relative to the second part in such a way as to cooperate by clamping at the respective contact surface thereof. At least one of the parts, preferably both parts, comprise on the contact surface thereof an abrasive covering.

### CROSS-REFERENCES TO RELATED APPLICATIONS

This application claims the benefit of the French patent application No. 1771422 filed on Dec. 22, 2017, the entire disclosures of which are incorporated herein by way of reference.

### BACKGROUND OF THE INVENTION

The invention relates to the field of electronic antitheft devices, more particularly, store electronic devices that allow self-service items in stores to be protected electronically.

A store electronic antitheft device, known by the initials EAS (Electronic Article Surveillance) comprises an electronic system enabling an alarm to be triggered when the antitheft device passes through a detection portal designed to detect the frequency emitted by the electronic antitheft system.

An electronic antitheft device can have various forms depending on the type of item to be protected. For example, it may involve an electronic label (usually called tag), or an antitheft device in a form suitable for bottles, textile items, spectacles, etc.

More particularly, the invention concerns an antitheft device capable of being attached to an item to be protected by bringing together two parts with a clamping or fastening effect on the object.

Electronic antitheft devices with a clamping function are known, such as those used for elongated items such as the temple pieces of spectacles.

This type of antitheft device comprises two parts, articulated relative to each other and each having a clamping contact surface with the item to be protected. Usually, each contact surface has a covering of plastic material to prevent damage to the item, and preferably is provided with means in relief such as teeth that cooperate by mutual engagement when the two contact surfaces are tightened against each other, and which are elastically deformable when they are pressed against the item.

However, it has been found that such an antitheft device with clamping function is not always suitable for certain items which, when clamped, can be damaged, marked or even ruined when the antitheft device is put in place or removed.

Items that cannot be protected by this type of antitheft device with clamping function are, in particular, those that have a flexible envelope, especially of aluminum foil, such as flexible metal packages for fresh products such as meat, coffee packets, foie gras, salmon, or items made of suede leather such as gloves, boots, women's shoes, etc.

Furthermore, packages made of aluminum also cannot be protected with electronic antitheft tags because the aluminum neutralizes the antitheft tag; nor can they be protected with stud-type antitheft devices because the stud would penetrate the package which would introduce air into the package and make the product unsuitable for consumption.

Finally, leather products that today are punctured by conventional stud-type antitheft devices are damaged by the holes left by the antitheft studs.

Consequently, still today there are self-service items that cannot be electronically protected by the antitheft devices existing on the market, without the risk of damaging or ruining them.

### SUMMARY OF THE INVENTION

A purpose of the invention, therefore, is to obviate these disadvantages by proposing an electronic antitheft device that can be reliably secured and/or maintained on the object to be protected, without penetrating, impairing, or damaging the object, while being simple to implement.

To that end, according to the invention, the electronic antitheft device comprises electronic detection means, a first part and a second part each of which is provided with a so-called contact surface, the first part being movable relative to the second part in such a way as to cooperate by clamping at the contact surface thereof, the antitheft device being characterized in that at least one of the parts, preferably both parts, comprise an abrasive covering on the contact surface thereof. The abrasive covering is intended to be in direct contact with the object to be clamped.

Surprisingly, it has been found that the surface with abrasive covering ensures an optimal clamping of the object, thus better preventing the removal of the antitheft device if the object or the antitheft device is pulled when it is in the closed, clamped position.

Contrary to expectations, the abrasive covering whose function is normally to rub/polish in order to refurbish a surface by stripping it, leaves no mark on the item during clamping and after removal of the device.

Thus, the abrasive covering, which is totally repurposed from its stripping function, combined with the clamping function of the two parts of the device, is used as a securing means and unexpectedly achieves a mechanically secure antitheft device preventing any risk of damage to the item to be protected.

The first movable part is advantageously movable in rotation relative to an axis of rotation. The axis of rotation is disposed in a central part of the assembly of the device.

The first part is movable in rotation/pivoting relative to the second part between a first extreme open position, and a second extreme position called closed, where the two respective contact surfaces are intended to clamp onto the item to be protected electronically.

The size of the device and the angle of opening of the two clamping parts will depend on the thickness of the item to be clamped.

For example, a maximum angle of 60° is sufficient for items with a thickness of no more than 3 to 5 mm. Of course, the device can be adapted for greater thicknesses. According to one characteristic, the abrasive covering includes, on the one hand, a support made integral with the part or parts suitable for clamping, by one of the faces thereof, the support in particular being paper, textile, tissue, polymer or synthetic fibers, and on the other hand abrasive grains that are borne by the support on the opposite engaging face of the support. The abrasive grains can be of mineral or synthetic material.

According to another characteristic, the abrasive covering has a roughness for which the grain (according to the classification of the Federation Européenne des Producteurs d′Abrasifs [European Federation of Abrasives Producers], FEPA, which also corresponds to the standard ISO 6344) is between P50 and P800, preferably between P50 and P400, and still more preferably between P80 and P120.

Preferably, the abrasive covering is of emery cloth.

According to another characteristic, the abrasive covering covers all or part of the contact surfaces.

The abrasive covering is glued or thermally bonded or over-molded onto the clamping parts, or the bodies of the clamping parts are over-molded onto the covering.

Advantageously, the contact surfaces are parallel to each other.

Advantageously, the electronic detection means are housed inside the second movable clamping part.

The antitheft device comprises means of locking the two parts in the closed position, and in particular the locking means are arranged opposite the opening of the two parts.

In a preferred embodiment, the locking means comprise a toothed tongue suitable for cooperating with a toothed retention part which is movable and is associated with a magnetic material, the magnetic material being housed in an element projecting from the body of the device and disposed opposite to the first and second clamping parts.

The locking means of the device are designed to maintain the second movable part secured in the clamped/closed position.

The magnetic material and the mobility of the retention part enable the unlocking and opening of the device (the opening of the movable clamping part).

Advantageously, the locking means can be actuated via a pressing member (manual), preferably the pressing member having on the outer face thereof, facing the external environment, a concave surface/depression to facilitate the positioning of the user's finger.

According to another characteristic, the first movable part is articulated in rotation relative to an axis of rotation, the device preferably comprising a pressing member that is associated with the axis of rotation and participates in the closure of the device, in particular the pressing member being integral with a gripping part extending the movable part on the other side of the axis of rotation. In the open position of the device, the pressing member protrudes from the rest of the body of the device.

The axis of rotation can be provided with a return spring for the automatic opening of the clamping parts once the device is unlocked.

Finally, the invention concerns the utilization of the electronic antitheft device of the invention for self-service items, especially items being in flexible or semi-rigid or rigid packaging, such as a thickness in the order of no more than 5 mm (between 0.1 mm and 5 mm), and/or the item has a cooperation surface of the type made of aluminum, or of plastic material or of suede leather.

### BRIEF DESCRIPTION OF THE DRAWINGS

The present invention is now described by way of examples that are solely illustrative and in no way limit the scope of the invention, and from the appended illustrations in which:

FIG. 1 represents a view in perspective of one of the faces of the antitheft device according to the invention, in the open position;

FIG. 2 is a view in perspective of the opposite face of the antitheft device of FIG. 1;

FIG. 3 is a view of the antitheft device of FIG. 2 in the closed position;

FIG. 4 is a side view of the antitheft device of FIG. 3;

FIG. 5 is a top view of the antitheft device of FIG. 1;

FIG. 6 is a view in perspective of the antitheft device of the invention clamped onto a pair of leather gloves, only the open end of the gloves being visible;

FIG. 7 is a top view in perspective of product packaging, clamped by the antitheft device of the invention.

### DETAILED DESCRIPTION OF THE PREFERRED EMBODIMENTS

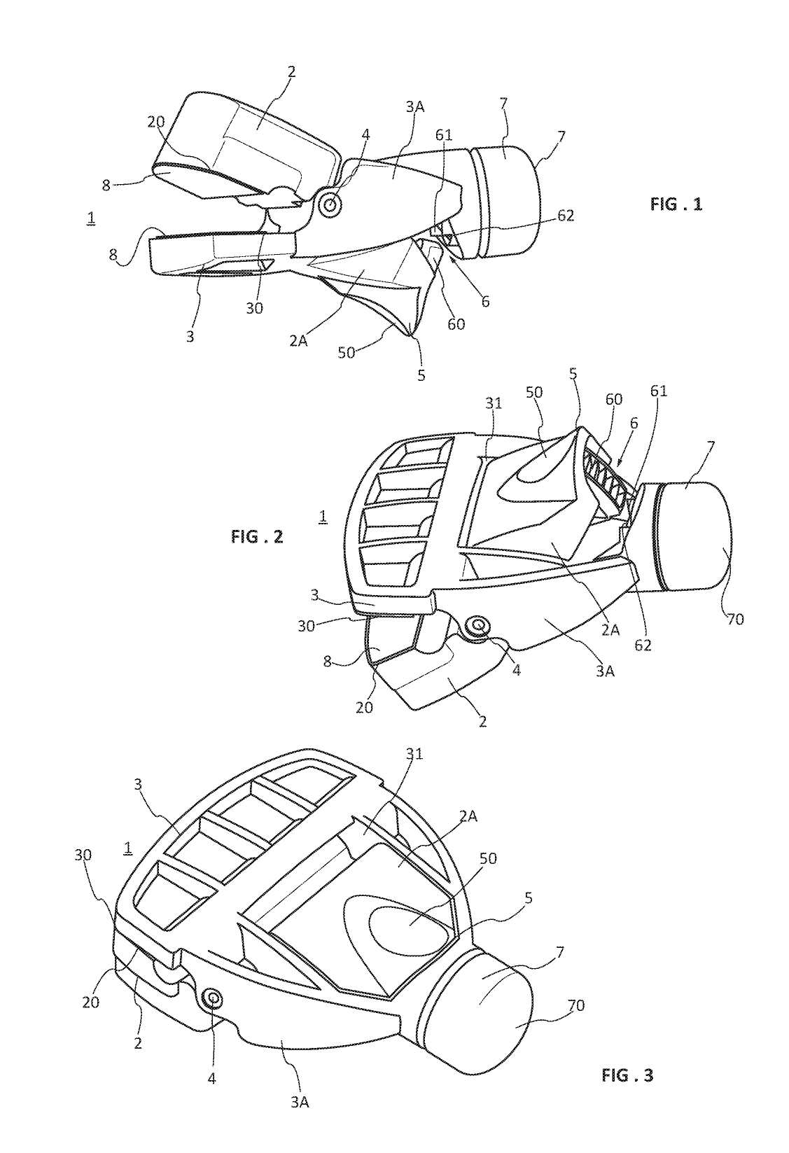

The electronic antitheft device 1 according to the invention illustrated in FIG. 1 and following is intended to be attached by clamping onto a self-service store item to be protected, such as a pair of gloves (FIG. 6), or a flexible semi-rigid or rigid packaging of a food product, for example, such as meat in flexible aluminum packaging, or fish in a semi-rigid packaging (FIG. 7).

The electronic antitheft device 1 comprises according to the invention:

two clamping parts 2 and 3 that are articulated relative to each other along an axis of rotation 4 in order to procure a device in the open condition, as illustrated in FIGS. 1 and 2, or in the closed condition (FIGS. 3 to 7), the first clamping part 2 (called movable part) being, for example, movable relative to the second part 3 (called fixed part);

two gripping parts 2A and 3A that are extensions of the respective clamping parts 2 and 3, transverse to the axis of rotation 4 (therefore opposite the opening of the clamping parts of the device);

electronic protection means, not visible, and preferably housed in a slightly thicker part of the body of the movable clamping part 2, the electronic protection means not being described in detail because they are known, such as by radiofrequency, acousto-magnetic, RFID and other electronic technologies;

an actuating/pressing member 5 for the closing of the device which advantageously forms or is borne by the gripping part 2A of the movable part 2;

locking means 6 enabling the device to be locked in the closed/clamped position, and

an element 7 protruding from the gripping part 3A of the fixed part 3, the element being disposed opposite the clamping parts 2 and 3 and participating in the unlocking of the two clamping parts 2 and 3 when they are closed in order to open the device.

The clamping parts 2 and 3, the gripping parts 3A, 2A, the pressing member 5, the locking means 6 and the protruding element 7 are made of rigid plastic, for example polyvinyl chloride (PVC).

In the illustrated example, each clamping part 2 and 3 has a substantially parallelepiped shape, which is in no way limiting, the large dimension of which defines a longitudinal direction, which is also that of the axis of rotation 4.

The movable part 2 is movable in rotation, relative to the fixed part 3, between two extreme positions, namely:
an open position (FIGS. 1 and 2), for example up to a maximum opening angle of about 60°;
a closed or folded position (FIGS. 3 to 7) for which, when there is no object placed between the parts, the movable part 2 and fixed part 3 bear against each other, and when an object is positioned between the parts, the movable part 2 clamps against the object while the fixed part is already in place on the opposite face of the object.

The movable clamping part 2 is articulated via the axis of rotation 4.

The clamping parts 2 and 3 and their respective gripping part 2A, 3A are crossed relative to the axis of rotation 4 in order to form a clamp.

The axis of rotation 4 can be associated with a return spring. If a return spring is present, the return spring has a rest position when the movable part 2 is fully open, and the movable part 2 is forced into the closed/clamping position against the fixed part 3. The return spring enables the movable clamping part 2 to be opened automatically when the release is actuated.

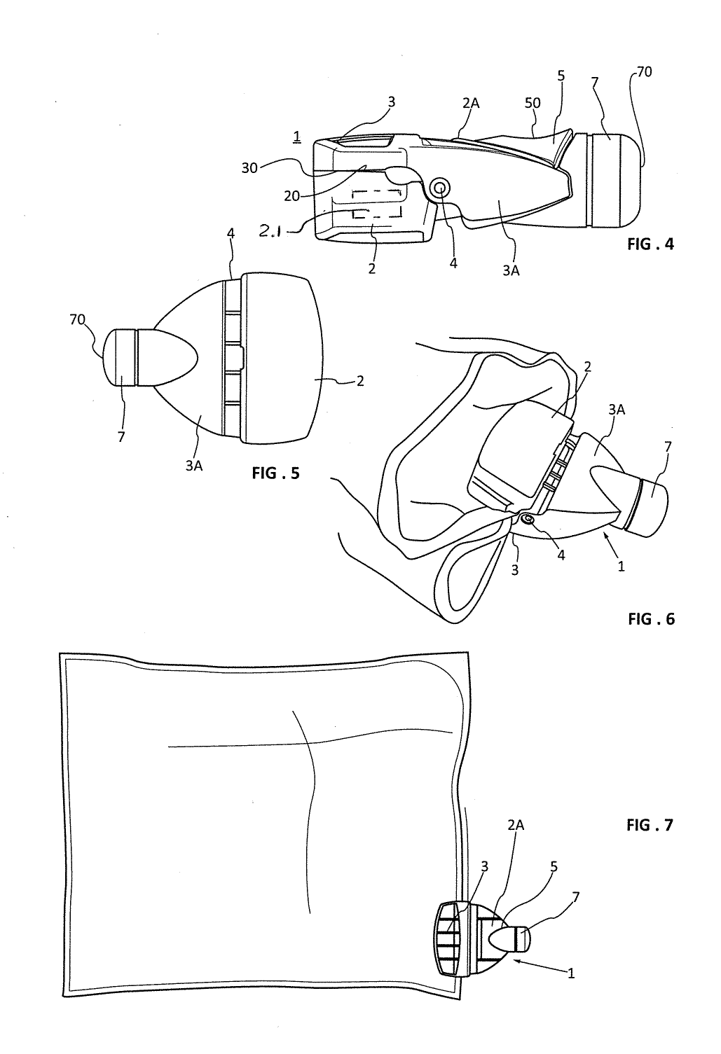

The interior of each clamping part 2 and 3 has a contact surface 20, respectively 30 (FIGS. 1 to 3) which will be described hereinafter. In the closed position of the antitheft device with no object clamped therein, the contact surfaces 20 and 30 are in contact, or quasi-contact, or very close to each other (FIG. 4).

The movable part 2 (higher/thicker than the fixed part 3) invisibly houses the electronic protection means 2.1 intended in the event of theft to cooperate with detection means and sensors disposed at the exits of the store. The electronic protection means, which are known as such, are not described in more detail.

The gripping part 3A of the fixed part 3 includes on one of the principal faces thereof, opposite the face extending the movable part 2 and between the axis of rotation 4 and the protruding element 7, a recess 31 for the gripping part 2A of the movable part 2 to emerge.

Pressing on the gripping part 2A of the movable part 2 causes the pivoting of the movable part 2 relative to the axis of rotation 4. The recess 31 enables the receiving or extraction of the gripping part 2A carrying the actuating/pressing member 5. The pressing member 5 assists in the closing (and therefore the clamping) of the movable clamping part 2 when pressure is applied from above, for example with a finger.

Advantageously, the pressing member 5 has on the outer face thereof, facing the exterior environment, a concave surface/depression 50 to facilitate the positioning of the user's finger.

The locking means 6 are provided to temporarily close (until unlocking) the two clamping parts 2 and 3 against each other.

The locking means 6 comprise (FIG. 2) opposite the axis of rotation 4, on the one hand, a toothed tongue 60 that extends in a plane substantially perpendicular to the axis of rotation 4 and in a direction along the thickness of the device, while being integral with the free end of the pressing member 5, and, on the other hand, a receiving housing 61 borne by the interface of the protruding element 7 facing the recess 31, the housing 61 being of complementary shape to the tongue 60 and provided with a retention part 62 which is movable by pivoting or translation in order to be able to move away from the tongue 60 by shifting towards the interior of the element 7.

The retention part 62 is toothed on the inner face thereof in the housing 61 so as to cooperate mutually with the toothed tongue 60 when the tongue is inserted into the receiving housing 61, in such a way as to lock the closure of the device.

The movable toothed retention part 62 has on the opposite face thereof, the face housed inside the protruding element 7, a part made of magnetic material, not shown here.

The protruding element 7 has a terminal outer face 70 which is intended to cooperate with the usual antitheft detachment tool (not shown), generally called the detacher and formed from a powerful magnet to cause the opening of the clamping parts 2 and 3. In the support position of the protruding element 7 against the detacher, the magnetic part of the movable retention part 62 is attracted towards the detacher causing the movement of the retention part 62 towards the interior of the element 7 and in the opposite direction of the pressing member 5 and the toothed tongue 60, which frees the coupling of the mutual teeth of the tongue 60 and the retention part 62 and thus unlocks the closure of the two clamping parts 2 and 3.

The two clamping parts 2 and 3 can be pulled to open the clamp/device.

In a case in which there is a return spring present, due to the association of the pressing member 5 (gripping part 2A of the movable part 2) with the return spring of the axis of rotation 4, when the toothed tongue 60, which is integral with the pressing member 5, is separated from the retention part 62 that was attracted by the detacher, the tongue 60 is ejected from the housing 61 and the movable clamping part 2 then opens automatically.

Preferably, the gripping part 2A of the movable part 2 with the pressing member 5, and the protruding element 7 have a thickness (height) dimension that is perpendicular to the axis of rotation 4 and to the plane of the contact surfaces of the clamping parts 2 and 3, which does not (or does not substantially) exceed the height/thickness of the two clamping parts 2 and 3 in the closed position, as illustrated in FIG. 4. Thus, the device takes up little space.

As far as the clamping is concerned, the contact surfaces 20 and 30 form clamping surfaces for the object, between which the object is intended to be sandwiched firmly. For example, the gloves (FIG. 6) and the flexible envelope (FIG. 7), are tightened or clamped between the contact surfaces 20 and 30.

According to the invention, the contact surfaces 20 and 30 are such that they allow optimal tightening of the object, ensuring that the antitheft device 1 is held firmly in place, and without risk of the antitheft device opening or of it being pulled off, or of damage to the clamped surface of the object if the device is pulled inadvertently when in the closed condition thereof.

According to the invention, the contact surfaces 20 and 30 comprise an abrasive covering 8. In the preferred embodiment, the abrasive covering 8 is emery cloth. In particular, it has a grain size between P80 and P120.

The covering 8 is made integral with the inner face of the clamping parts 2 and 3, preferably by gluing.

Preferably, the covering 8 is made integral with the entirety of the inner face of both clamping parts 2 and 3.

The utilization of the antitheft device 1 is as follows.

Advantageously, the user needs only one hand to manipulate the antitheft device and to ensure its closure around the object that is held with the other hand.

The user having picked up the antitheft device 1 by the gripping parts 2A and 3A, the pressing member 5 protruding from the outer surface of the rest of the device's body and the clamping parts 2 and 3 being in the open condition, he positions the two clamping parts 2 and 3 to overlap the object to be protected. He then places his finger against the pressing member 5, more particularly on the surface 50 for positioning the finger. By pressing on the pressing member 5, the member swings towards the interior of the device, at the same time the movable clamping part 2 is closed, the toothed tongue 60 is inserted into the housing 61 and cooperates with the toothed retention part 62 until the respective contact surfaces 20 and 30 press upon the object. The antitheft device is locked.

The device of the invention thus makes it possible to be attached to the object in a locked manner, while very effectively resisting being removed by pulling upon the object without risk of damaging the object thanks to the abrasive covering 8 of the contact surfaces 20 and 30.

To open the antitheft device 1, the user positions the protruding element 7 against a detacher, releasing the toothed tongue 60 which allows the opening of the clamping parts 2 and 3 and causes the pressing member 5 to swing back. The user can then remove the antitheft device from the object.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An electronic antitheft device comprising:
electronic detection means,
a first part and a second part, each of which is provided with an inner contact surface, and the first part being movable relative to the second part in such a way as to cooperate by clamping at the respective contact surface thereof,
wherein at least one of the first and second parts comprises an abrasive covering on the contact surface thereof.

2. The device according to claim 1, wherein both parts comprise an abrasive covering on the contact surface thereof.

3. The device according to claim 1, wherein the abrasive covering includes a support made integral with the part suitable for clamping, by a face thereof, the support, and abrasive grains borne by the support on an opposite engaging face of the support.

4. The device according to claim 3, wherein the abrasive covering comprises at least one of paper, textile, tissue, polymer or synthetic fibers.

5. The device according to claim 1, wherein the abrasive covering has a roughness, for which a grain is between P50 and P800.

6. The device according to claim 5, wherein the grain is between P50 and P400.

7. The device according to claim 5, wherein the grain is between P80 and P120.

8. The device according to claim 1, wherein the abrasive covering comprises emery cloth.

9. The device according to claim 1, wherein the contact surfaces are parallel to each other.

10. The device according to claim 1, wherein the abrasive covering covers at least a part of the contact surface.

11. The device according to claim 1, wherein the abrasive covering covers an entirety of the contact surface.

12. The device according to claim 1, wherein the abrasive covering is glued or thermally bonded onto the first and second parts.

13. The device according to claim 1, wherein bodies of the first and second parts are over-molded onto the covering.

14. The device according to claim 1, wherein the electronic detection means are housed inside the second movable clamping part.

15. The device according to claim 1, further comprising means of locking the first and second parts in the closed position.

16. The device according to claim 15, wherein the means of locking are arranged opposite the opening of the two parts.

17. The device according to claim 16, wherein the means of locking comprise a toothed tongue configured to cooperate with a movable toothed retention part and is associated with a magnetic material, the magnetic material being housed in an element projecting from the body of the device and disposed opposite to the first and second parts.

18. The device according to claim 1, further comprising means of locking the two parts in a closed position, which parts can be actuated via a pressing member, said pressing member having on the outer face thereof, facing an external environment, a concave surface.

19. The device according to claim 1, wherein the first movable part is articulated in rotation relative to an axis of rotation, the device comprising a pressing member associated with the axis of rotation and participating in a closure of the device.

20. The device according to claim 19, wherein the pressing member is integral with a gripping part extending the first movable part on the other side of the axis of rotation.
